(19) United States
(12) Patent Application Publication
(10) Pub. No.: US 2012/0294200 A1
(43) Pub. Date: Nov. 22, 2012

(54) WIRELESS COMMUNICATION METHOD

(75) Inventors: Yi-Ping WANG, Hsinchu (TW); Yung-Fa Ho, Hsinchu (TW)

(73) Assignee: Wistron NeWeb Corporation

(21) Appl. No.: 13/240,854

(22) Filed: Sep. 22, 2011

(30) Foreign Application Priority Data
May 19, 2011 (TW) 100117617

(51) Int. Cl. H04W 72/04

(52) U.S. Cl. 370/277

(57) ABSTRACT

A wireless communication method includes attempting to establish a first wireless connection. Next, an attempt is made to establish a second wireless connection using a different channel from the first wireless connection. Subsequently, a determination is made as to whether the first wireless connection and the second wireless connection are established. When the first wireless connection and the second wireless connection are established, a manner of signal transmission between the first wireless connection and the second wireless connection is coordinated to transmit uplink data and downlink data, respectively, such that a duplex mode of operation is realized.

### RELATED APPLICATIONS

This application claims priority to Taiwan Application Serial Number 100117617, filed May 19, 2011, which is herein incorporated by reference.

### BACKGROUND

1. Field of Invention

The present disclosure relates generally to an electronic communication method, and more particularly to a wireless communication method.

2. Description of Related Art

In order to provide a network connection service using different wireless network communication specifications such as Wi-Fi 802.11a/b/g/n, conventional wireless access points (APs) may be equipped with two radio frequency (RF) modules operating in different frequency bands (e.g., a 2.4 GHz frequency band and a 5 GHz frequency band) to provide the network connection service for clients or other wireless APs operated using different wireless network communication specifications.

However, a wireless AP equipped with two RF modules may use only one RF module at a time to perform a wireless connection in one frequency band (e.g., a 2.4 GHz frequency band) for transmitting uplink data and downlink data. At this time, the other RF module of the wireless AP may be idle, and as a result, wireless network resources will be wasted. Further, as wireless network devices become more and more popular, the number of wireless network users is continuously increasing. With limited wireless bandwidth and channels, this has resulted in interference between wireless network communications becoming more and more serious.

Therefore, a heretofore unaddressed need exists in the art to cope with the aforementioned deficiencies and inadequacies.

### SUMMARY

The present disclosure discloses a wireless communication method to improve transmission throughput and maintain communication quality of wireless communication.

One aspect of the present disclosure is to provide a wireless communication method including the following operations. First, establishing a first wireless connection is attempted. Next, establishing a second wireless connection using a different channel from the first wireless connection is attempted. Subsequently, a determination is made as to whether the first wireless connection and the second wireless connection are established. When the first wireless connection and the second wireless connection are established, a manner of signal transmission between the first wireless connection and the second wireless connection is coordinated to transmit uplink data and downlink data, respectively, such that a duplex mode of operation is realized.

According to one embodiment of the present disclosure, the first wireless connection and the second wireless connection use the same or different frequency bands in the duplex mode.

According to one embodiment of the present disclosure, the wireless communication method includes additional operations. When at least one of the wireless connections is unable to be established, the attempt to establish the connection is aborted. After the attempt to establish the connection is aborted, a determination is made as to whether a predetermined checking time is reached. When the predetermined checking time is reached, establishing at least one of the wireless connections is re-attempted.

According to one embodiment of the present disclosure, the wireless communication method includes additional operations after the duplex mode of operation is realized. First, a determination is made as to whether a predetermined checking time is reached. When the predetermined checking time is reached, a determination is made as to whether a connection status or communication quality of the first wireless connection and the second wireless connection is abnormal. When the connection status or communication quality of at least one of the wireless connections is abnormal, a determination is made as to whether a re-connection number or re-connection duration reaches a predetermined threshold. When the re-connection number or re-connection duration is less than the predetermined threshold, a re-connection process is performed with respect to at least one of the wireless connections having the abnormal connection status or communication quality. After the re-connection process is performed, a determination is made as to whether the first wireless connection and the second wireless connection are able to be established. When the first wireless connection and the second wireless connection are established, the duplex mode of operation performed is maintained.

Another aspect of the present disclosure is to provide a wireless communication method. First, establishing a first wireless connection is attempted. Next, establishing a second wireless connection using a different channel from the first wireless connection is attempted. Subsequently, a determination is made as to whether the first wireless connection and the second wireless connection are established. When the first wireless connection and the second wireless connection are established, a manner of signal transmission between the first wireless connection and the second wireless connection is coordinated to transmit uplink data and downlink data, respectively, such that a duplex mode of operation is realized. When only one wireless connection is established, the uplink data and the downlink data are transmitted by using the established wireless connection, such that a backup mode of operation is realized.

According to one embodiment of the present disclosure, the first wireless connection and the second wireless connection use the same or different frequency bands in the duplex mode.

According to one embodiment of the present disclosure, the wireless communication method includes additional operations. When the first wireless connection and the second wireless connection are unable to be established, the attempt to establish the connection is aborted. After the attempt to establish the connection is aborted, a determination is made as to whether a predetermined checking time is reached. When the predetermined checking time is reached, establishing the first wireless connection and the second wireless connection is re-attempted.

According to one embodiment of the present disclosure, the wireless communication method includes additional operations after the backup mode of operation is realized. First, the attempt to establish the connection is aborted. After the attempt to establish the connection is aborted, a determination is made as to whether a predetermined checking time is reached. When the predetermined checking time is reached, establishing the other wireless connection is re-attempted. When the first wireless connection and the second wireless connection are able to be established, the manner of signal transmission between the first wireless connection and the second wireless connection is coordinated to transmit the uplink data and the downlink data, respectively, and the operation is switched to the duplex mode.

According to one embodiment of the present disclosure, the wireless communication method includes additional operations after the operation is entered into the duplex mode. First, a determination is made as to whether a predetermined checking time is reached. When the predetermined checking time is reached, a determination is made as to whether a connection status or communication quality of the first wireless connection and the second wireless connection is abnormal. When the connection status or communication quality of at least one of the first wireless connection and the second wireless connection is abnormal, a determination is made as to whether a re-connection number or re-connection duration reaches a predetermined threshold. When the re-connection number or re-connection duration is less than the predetermined threshold, a re-connection process is performed with respect to at least one of the wireless connections having the abnormal connection status or communication quality. After the re-connection process is performed, a determination is made as to whether the first wireless communication and the second wireless communication are able to be established. When the first wireless connection and the second wireless connection are established, the duplex mode of operation is maintained.

According to one embodiment of the present disclosure, the wireless communication method further includes additional operations when the re-connection number or re-connection duration reaches the predetermined threshold. First, a determination is made as to whether only one wireless connection is established. When only one wireless connection is established, the uplink data and the downlink data are transmitted by using the established wireless connection, and the operation is switched from to the backup mode. When the first wireless connection and the second wireless connection are unable to be established, the operation is switched to an initial mode, and the attempt to establish the connection is aborted.

Therefore, the advantage of the present disclosure is to establish two unidirectional wireless connections by using different channels to transmit the uplink data and the downlink data, respectively, and these two unidirectional wireless connections both can be used to perform independent data transmission in each of two different channels, in order to double the wireless communication bandwidth and to improve the wireless transmission rate.

It is to be understood that both the foregoing general description and the following detailed description are by examples, and are intended to provide further explanation of the invention as claimed.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 shows schematically a block diagram of a wireless communication system according to one embodiment of the present disclosure.

FIG. 2 shows schematically a flow diagram of a wireless communication method according to a first embodiment of the present disclosure.

FIG. 3 shows schematically a flow diagram of a wireless communication method according to a second embodiment of the present disclosure.

FIG. 4 shows schematically a flow diagram of a wireless communication method according to a third embodiment of the present disclosure.

FIG. 5 shows schematically a flow diagram of a wireless communication method according to a fourth embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

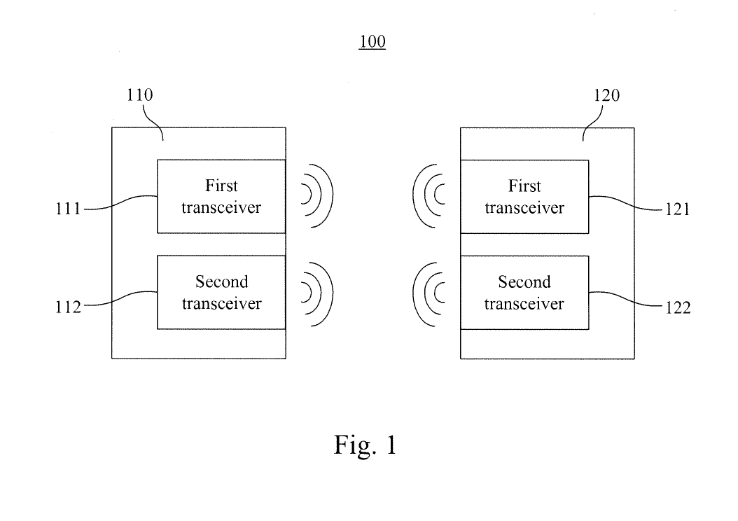

Referring to FIG. 1, a block diagram will be described that illustrates a wireless communication system 100 according to one embodiment of the present disclosure. The wireless communication system 100 includes a first wireless communication device 110 and a second wireless communication device 120, for performing wireless signal transmission with each other. The first wireless communication device 110 includes a first transceiver unit 111 and a second transceiver unit 112, for establishing two wireless connections using different channels. Similarly, the second wireless communication device 120 includes a first transceiver unit 121 and a second transceiver unit 122, for establishing two wireless connections using different channels.

For example, the first transceiver unit 111 of the first wireless communication device 110 can establish a wireless connection with one of the first transceiver unit 121 and the second transceiver unit 122 of the second wireless communication device 120. Simultaneously, the second transceiver unit 112 of the first wireless communication device 110 can establish another wireless connection with the other of the first transceiver unit 121 and the second transceiver unit 122 of the second wireless communication device 120. When these two wireless connections are established, a manner of signal transmission between the first wireless communication device 110 and the second wireless communication device 120 is coordinated to determine which one of the wireless connections performs uplink data transmission and which one of the wireless connections performs downlink data transmission, and then two unidirectional wireless connections are formed, such that a duplex mode of operation is realized.

In one embodiment of the present disclosure, the wireless connections described above use different channels to prevent interference with each other when wireless signal transmission is performed. For example, one of the wireless connections can be operated using the 7^{th} channel (center frequency is 2442 MHz) in the 2.4 GHz frequency band of the Wi-Fi 802.11g specification, in which a 20 MHz wireless bandwidth can be used to perform a unidirectional data transmission. Simultaneously, the other of the wireless connections can be operated using the 60^{th} channel (center frequency is 5300 MHz) in the 5 GHz frequency band of the Wi-Fi 802.11a specification, in which another 20 MHz wireless bandwidth can be used to perform the other unidirectional data transmission. Hence, the first communication device 110 and the second communication device 120 can use a 40 MHz wireless bandwidth to perform data transmission in the duplex mode, thereby realizing a doubling of wireless bandwidth and an improvement in the wireless communication quality. The frequency band and the channel selection of the wireless connections may be selected based on actual transmission requirements of the wireless channels, and the present disclosure is not limited in this regard.

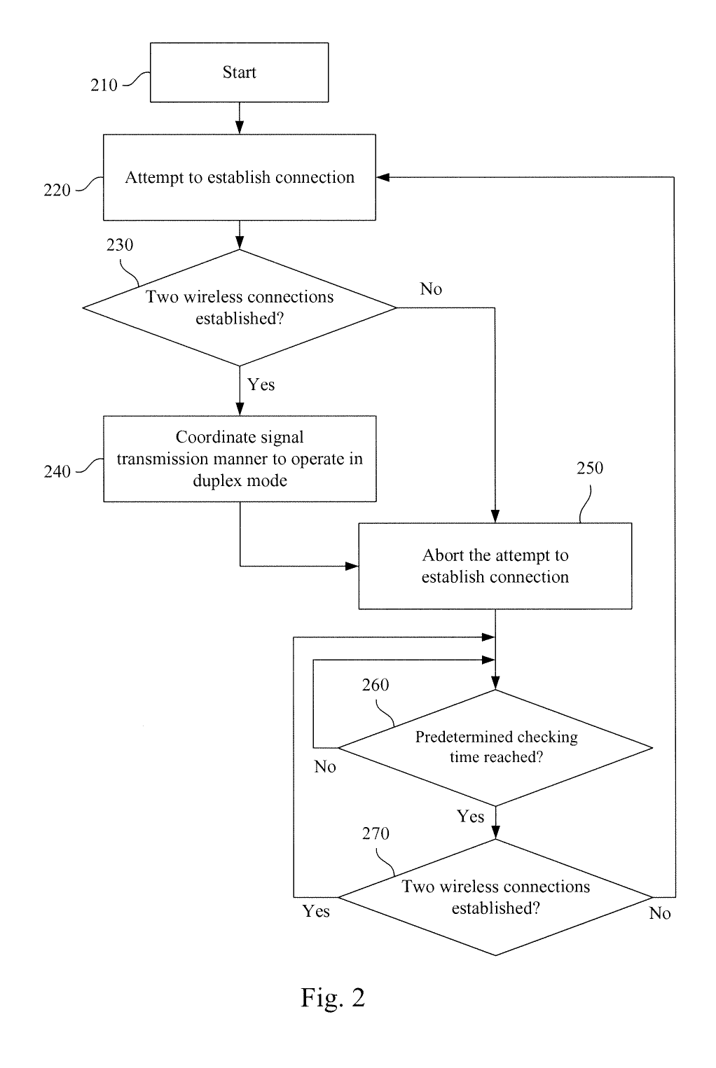

Reference is now made to both FIG. 1 and FIG. 2. A flow diagram will be described in FIG. 2 that illustrates a wireless communication method according to a first embodiment of the present disclosure. It is noted that the present embodiment uses the same or similar wireless communication system 100 as shown in FIG. 1 to realize wireless connections, and thus a description about the structure of the present embodiment will not be repeated herein.

In operation 210, an initial process of the wireless communication system is performed. For example, the first wireless communication device 110 and the second wireless communication device 120 start to perform a searching process for available channels in this operation, in order to provide a foundation to establish the wireless connections.

In operation 220, establishing a first wireless connection is attempted, after which establishing a second wireless connection using a different channel from the first wireless connection is attempted. For example, the first wireless communication device 110 and the second wireless communication device 120 attempt to establish two wireless connections using different channels. Namely, the first wireless connection can be established by using the 7^{th} channel (center frequency is 2442 MHz) in the 2.4 GHz frequency band of the Wi-Fi 802.11g specification, and the second wireless connection can be established by using the 60^{th} channel (center frequency is 5300 MHz) in the 5 GHz frequency band of the Wi-Fi 802.11a specification. The frequency band and the channel selection of the wireless connections may be selected based on actual transmission requirements of the wireless channel, and the present disclosure is not limited in this regard.

In operation 230, a determination is made as to whether the first wireless connection and the second wireless connection are established. For example, the first wireless communication device 110 and the second wireless communication device 120 can determine whether two wireless connections using different channels are able to be established.

In operation 240, when the first wireless connection and the second wireless connection are established, coordination of the manner of signal transmission between the first wireless connection and the second wireless connection is performed to transmit the uplink data and the downlink data, respectively, such that the duplex mode of operation is realized. For example, when two wireless connections performing the wireless signal transmission between the first wireless communication device 110 and the second wireless communication device 120 are able to be established, coordination of the manner of signal transmission between the first wireless communication device 110 and the second wireless communication device 120 can be performed to determine which one of the wireless connections performs the uplink data transmission and which one of the wireless connections performs the downlink data transmission, and then two unidirectional wireless connections are formed such that the duplex mode of operation is realized. After that, the attempt to establish the wireless connection is aborted after the duplex mode of operation is realized, as shown in operation 250. No matter the operation mode is performed in the duplex mode or the other modes, the wireless connection will attempt to be established again periodically.

In one embodiment of the present disclosure, the first wireless connection and the second wireless connection can use the same or different frequency bands in the duplex mode. For example, the first wireless connection can be established by using the 7^{th} channel (center frequency is 2442 MHz) in the 2.4 GHz frequency band of the Wi-Fi 802.11g specification, and the second wireless connection can be established by using the 11^{th} channel (center frequency is 2462 MHz) in the 2.4 GHz frequency band of the Wi-Fi 802.11g specification. Further, the second wireless connection can be established by using the 60^{th} channel (center frequency is 5300 MHz) in the 5 GHz frequency band of the Wi-Fi 802.11a specification. It is noted that as long as a suitable frequency interval is maintained between the wireless channels of the first wireless connection and the second wireless connection, interference between the wireless connections can be prevented to thereby maintain well communication quality.

In one embodiment of the present disclosure, the wireless communication method includes additional operations. When at least one of the wireless connections (e.g. the first wireless connection or the second wireless connection or both of them) is unable to be established, the attempt to establish the connection is aborted, as shown in operation 250. After the attempt to establish the connection is aborted, a determination is made as to whether a predetermined checking time is reached, as shown in operation 260. When the predetermined checking time is reached, establishing at least one of the wireless connections is re-attempted, such that, two wireless connections (e.g. the first wireless connection and the second wireless connection) can be established after the re-connection process is performed, and the duplex mode of operation is realized.

For example, in operation 230 of the foregoing embodiment, a determination is made as to whether two wireless connections between the first wireless communication device 110 and the second wireless communication device 120 are established. When at least one wireless connection is unable to be established, operation 250 is performed to abort the attempt to establish the connection at this time and waiting for next re-connection process. Next, in operation 260, a determination is made as to whether a predetermined checking time for attempting to establish the connection periodically is reached. When the predetermined checking time is reached, a determination is made as to whether two wireless connections are established in operation 270. When two wireless connections are unable to be established or communication quality of two wireless connections are not good enough, the routine returns back to operation 220 of attempting to establish two wireless connections. It is noted that if one wireless connection has been established, the other wireless connection which has not been established has to be established to form two wireless connections in operation 220, such that the first wireless communication device 110 and the second wireless communication device 120 can operate in the duplex mode.

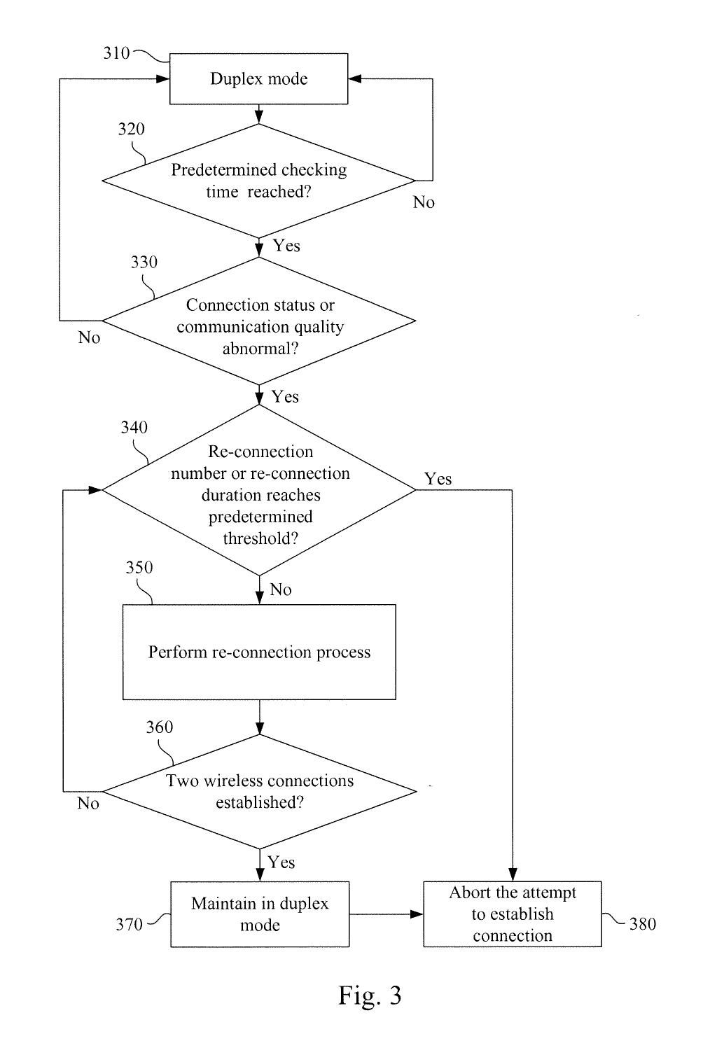

Reference is now made to both FIG. 1 and FIG. 3. A flow diagram will be described in FIG. 3 that illustrates a wireless communication method according to a second embodiment of the present disclosure. It is noted that the present embodiment uses the same or similar wireless communication system 100, as shown in FIG. 1, to realize wireless connections, and thus a description about the structure of the present embodiment will not be repeated herein.

In one embodiment of the present disclosure, the wireless connection is operated in the duplex mode as shown in operation 310, and further includes operations 320 to 380 as described below.

In operation 320, a determination is made as to whether a predetermined checking time is reached. For example, when the wireless connections operated between the first wireless communication device 110 and the second wireless communication device 120 enter into the duplex mode, then after the predetermined checking time is reached, determining a connection status or communication quality is periodically performed.

In operation 330, when the predetermined checking time is reached, a determination is made as to whether the connection status or communication quality of the first wireless connection and the second wireless connection is abnormal. For example, the first wireless communication device 110 and the second wireless communication device 120 will check whether the connection status or communication quality of two wireless connections being established is abnormal including the wireless connection is lost or the communication quality is less than a threshold.

In operation 340, when the connection status or communication quality of at least one of the first wireless connection and the second wireless connection is abnormal, a determination is made as to whether a re-connection number or re-connection duration reaches a predetermined threshold. For example, when a transmission rate in one of the wireless connections drops below 6 Mbps or a throughput test result is less than 12 Mbps in the duplex mode, the first wireless communication device 110 and the second wireless communication device 120 will determine whether it is necessary to perform a re-connection process in accordance with a predetermined parameter of the transmission rate or the throughput test result. Before the re-connection process is performed, the first wireless communication device 110 and the second wireless communication device 120 can determine whether the re-connection number has reached 10 or the re-connection duration has reached 10 seconds of the predetermined threshold setting to thereby provide a foundation to determine whether the re-connection process has to be performed. It is noted that the predetermined parameter for determining the connection status or communication quality of the wireless connections and the predetermined threshold for setting the re-connection number or re-connection duration are not intended to be limited in the present disclosure.

In operation 350, when the re-connection number or re-connection duration is less than the predetermined threshold, the re-connection process is performed with respect to at least one of the wireless connections having the abnormal connection status or communication quality. After the re-connection process is performed, a determination is made as to whether the first wireless communication and the second wireless communication are able to be established in operation 360.

For example, when the re-connection number is less than 10 or re-connection duration is less than 10 seconds, the first wireless communication device 110 and the second wireless communication device 120 will perform the re-connection process to establish the wireless connections when the transmission rate drops below 6 Mbps or the throughput test result is less than 12 Mbps. After the re-connection process is performed, a determination is made as to whether two wireless connections can be established successfully.

In operation 370, when the first wireless connection and the second wireless connection are established, the duplex mode of operation is maintained. For example, if two wireless connections can be established after the re-connection process is performed with respect to the wireless connection having the abnormal connection status or communication quality, the operations of the first wireless communication device 110 and the second wireless communication device 120 are maintained in the duplex mode. Next, the attempt to establish the connection is aborted at this time, as shown in operation 380.

Moreover, when two wireless communications between the first wireless communication device 110 and the second wireless communication device 120 are unable to be established, as determined in operation 360, operation 340 is performed to determine whether the re-connection number or re-connection duration has reached the predetermined threshold. When the re-connection number or re-connection duration is less than the predetermined threshold, the re-connection process is performed periodically to establish the wireless connection having the abnormal connection status or communication quality, as shown in operation 350. When the re-connection number or re-connection duration reaches the predetermined threshold, operation 380 is performed to abort the attempt to establish the connection, until the next predetermined checking time is reached, at which time establishing the connection is attempted again.

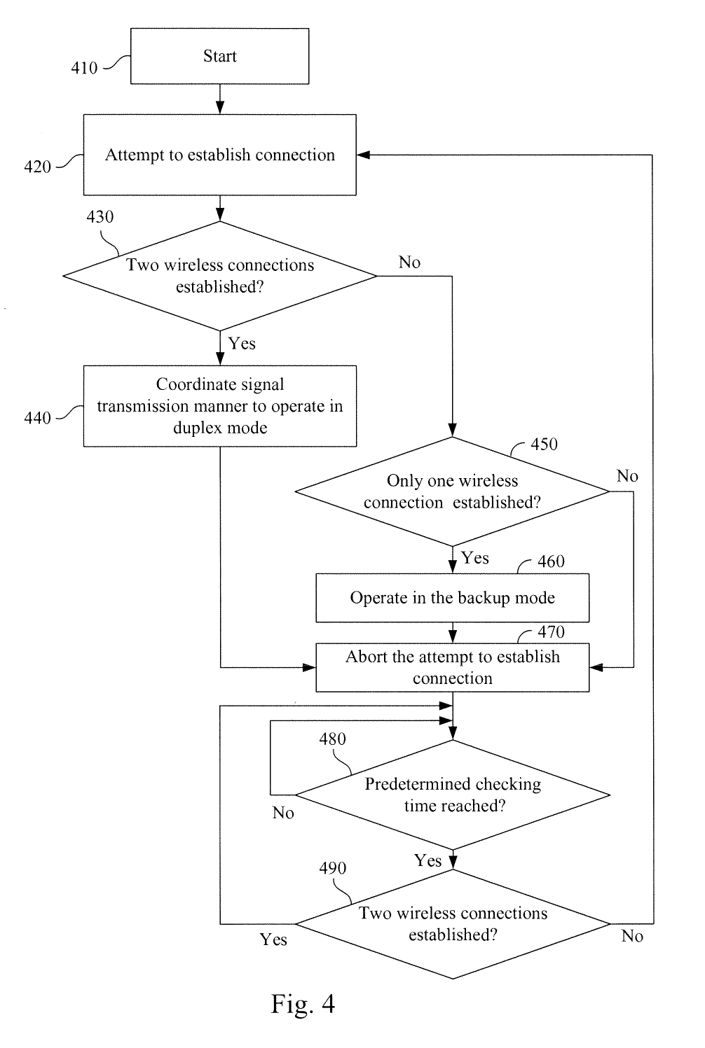

Reference is now made to FIG. 1, FIG. 2 and FIG. 4. A flow diagram will be described in FIG. 4 that illustrates a wireless communication method according to a third embodiment of the present disclosure. It is noted that the present embodiment uses the same or similar wireless communication system 100 as shown in FIG. 1 to realize wireless connections, and operations 410 to 440 in the present embodiment are the same as or similar to operations 210 to 240, as shown in FIG. 2, and thus a description thereof will not be repeated herein.

In operation 450 and 460, when only one wireless connection is established, the uplink data and the downlink data are transmitted by the established wireless connection, such that a backup mode of operation is realized. For example, when only one wireless connection using the 7^{th} channel of the 2.4 GHz band in the Wi-Fi 802.11g specification is established between the first wireless communication device 110 and the second wireless communication device 120, a 20 MHz wireless bandwidth of the 7^{th} channel can be used by the first wireless communication device 110 and the second wireless communication device 120 to transmit the uplink data and the downlink data, such that the backup mode of operation is realized and well communication quality is maintained.

In one embodiment of the present disclosure, the operations to establish the first wireless connection and the second wireless connection in the duplex mode are the same as or similar to the forgoing embodiment operated in the same or different frequency bands, and thus a description in this regard will not be repeated herein.

In one embodiment of the present disclosure, the wireless communication method includes additional operations. When the first wireless connection and the second wireless connection are unable to be established, the attempt to establish the connection is aborted, as shown in operation 470. After the attempt to establish the connection is aborted, a determination is made as to whether a predetermined checking time is reached, as shown in operation 480. When the predetermined checking time is reached, establishing the first wireless connection and the second wireless connection is re-attempted.

For example, when the wireless connections between the first wireless communication device 110 and the second wireless communication device 120 are unable to be established in operation 450, operation 470 is performed to abort the attempt to establish the connection at this time. Next, a determination is made as to whether the predetermined checking time is reached in operation 480. When the predetermined checking time is reached, a determination is made as to whether two wireless connections are established in operation 490. When these two wireless connections are unable to be established, the routine returns back to operation 420 to attempt to establish two wireless connections between the first wireless communication device 110 and the second wireless communication device 120.

In one embodiment of the present disclosure, the wireless communication method includes additional operations in the backup mode. In operation 470, the attempt to establish the connection is aborted. After the attempt to establish the connection is aborted, a determination is made as to whether a predetermined checking time is reached as shown in operation 480. When the predetermined checking time is reached, the routine returns back to operation 420 to re-attempt to establish the other wireless connection. When the first wireless connection and the second wireless connection are established, coordination of the manner of signal transmission between the first wireless connection and the second wireless connection is performed to transmit the uplink data and the downlink data, respectively, and the operation is switched to the duplex mode.

For example, when only one wireless connection can be established between the first wireless communication device 110 and the second wireless communication device 120, the backup mode of operation is realized in operation 460, such that well communication quality is maintained. Subsequently, the first wireless communication device 110 and the second wireless communication device 120 abort the attempt to establish the connection at this time, as shown in operation 470. Next, operation 480 is performed to determine whether the predetermined checking time is reached. When the predetermined checking time is reached, a determination is made as to whether two wireless connections are established in operation 490. When the wireless connections are unable to be established or the communication quality is not good enough, the routine returns back to operation 420 to attempt to establish the wireless connection, which has not been established. The connection status and the communication quality of the wireless connection, which has been established, can be determined in the backup mode, in order to maintain well communication quality. When two wireless connections can be established after the re-connection process is performed, coordination of the signal transmission method of the wireless connections is performed to realize two unidirectional full-rate data transmissions to transmit the uplink data and the downlink data, respectively, and the operation of the first wireless communication device 110 and the second wireless communication 120 is switched to the duplex mode.

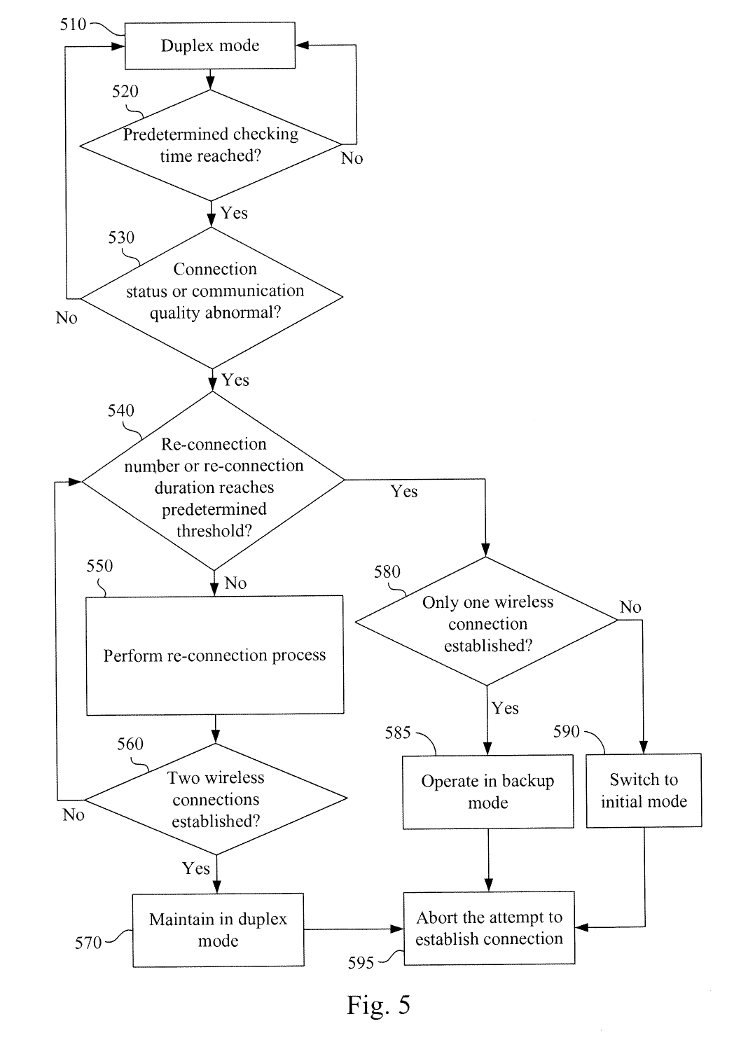

Reference is now made to FIG. 1, FIG. 3 and FIG. 5. A flow diagram will be described in FIG. 5 that illustrates a wireless communication method according to a fourth embodiment of the present disclosure. It is noted that the present embodiment uses the same or similar wireless communication system 100 as shown in FIG. 1 to realize wireless connections in the duplex mode in this embodiment, and operations 510 to 570 are the same as or similar to as operations 310 to 370 in FIG. 3, and thus a description in this regard will not be repeated herein.

In one embodiment of the present disclosure, when the re-connection number or re-connection duration of the wireless connection reaches the predetermined threshold, the method includes additional operations as described below.

In operation 580, a determination is made as to whether only one wireless connection is established. When only one wireless connection is established, the uplink data and the downlink data are transmitted by using the established wireless connection, and the operation is switched to the backup mode in operation 585. When the first wireless connection and the second wireless connection are unable to be established, the operation is switched to an initial mode (or called fail try mode). Next, the attempt to establish the connection is aborted in operation 595.

For example, when the wireless connections are operated in the duplex mode, a determination is made as to whether the communication quality is good enough. When the communication quality in the duplex mode is not good enough, the re-connection process will be performed. When the re-connection number or re-connection duration reaches the predetermined threshold in operation 540, a determination is made as to whether only one wireless connection can be established between the first wireless communication device 110 and the second wireless communication device 120 in operation 580. When only one wireless connection is established between the first wireless communication device 110 and the second wireless communication device 120, the established wireless connection is used for transmitting the uplink data and the downlink data between the first wireless communication device 110 and the second wireless communication device 120, and the operation is switched to the backup mode, as shown in operation 585. When the wireless connections between the first wireless communication device 110 and the second wireless communication device 120 are unable to established, the operation of first wireless communication device 110 and the second wireless communication device 120 is switched to the initial mode, as shown in operation 590. Subsequently, the first wireless communication device 110 and the second wireless communication device 120 perform a channel searching process in the initial mode, in order to provide a foundation for wireless channel switching and re-connection. Next, the attempt to establish the connection is aborted in operation 595, and after the predetermined checking time is reached, establishing the connection is attempted again.

Therefore, two unidirectional wireless connections having different transmission directions can be established between two wireless communication devices to perform independent data transmission, in order to double the wireless communication bandwidth and improve the wireless transmission rate.

For example, when a wireless communication apparatus having dual-band capability is operated in a 3T3R MIMO communication mode of the Wi-Fi 802.11n specification, the ideal data transmission rate of the communication mode can reach 450 Mbps. It is noted that the ideal data transmission rate of the wireless communication apparatus can be doubled up to 900 Mbps by using the concepts provided in the present disclosure with the same hardware structures.

Due to the fact that these two unidirectional wireless connections can be operated in different wireless channels or frequency bands, interference between these two wireless connections can be avoided, such that well communication quality of the wireless transmission is maintained. If one of the wireless connections is affected by interference, the operation can switch to the backup mode, such that the other wireless connection that is not affected by interference can perform dual-directional data transmission, in order to maintain well communication quality. Moreover, the wireless connection that is affected by interference attempts to establish the connection periodically when the predetermined checking time is reached, in order to recover the operation to the duplex mode with a high-speed wireless transmission rate. It is noted that the process of re-attempting to establish the connection further includes channel searching and channel switching, such that the wireless communication device can switch to a clean wireless channel to re-attempt to establish the connection again. The foregoing examples described herein are for illustration purposes only and are not intended to limit the scope of the present disclosure. The operations and the structures of the present embodiments may be adjusted to suit various practical applications without departing from the spirit and scope of the present disclosure.

In sum, the present disclosure has the advantage of doubling the transmission bandwidth, increasing the wireless transmission rate and establishing the wireless connection backup. Further, a network backbone can be established with wireless technology by using the transmission structure as shown in the present disclosure.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A wireless communication method, comprising:
attempting to establish a first wireless connection;
attempting to establish a second wireless connection using a different channel from the first wireless connection;
determining whether the first wireless connection and the second wireless connection are established; and
coordinating a manner of signal transmission between the first wireless connection and the second wireless connection to transmit uplink data and downlink data, respectively, when the first wireless connection and the second wireless connection are established, such that a duplex mode of operation is realized.

2. The wireless communication method of claim 1, wherein the first wireless connection and the second wireless connection use the same or different frequency bands in the duplex mode.

3. The wireless communication method of claim 1, further comprising:
aborting the attempt to establish the connection when at least one of the wireless connections is unable to be established;
determining whether a predetermined checking time is reached after the attempt to establish the connection is aborted; and
re-attempting to establish at least one of the wireless connections when the predetermined checking time is reached.

4. The wireless communication method of claim 1, further comprising the following steps after the duplex mode of operation is realized:
determining whether a predetermined checking time is reached;
determining whether a connection status or communication quality of the first wireless connection and the second wireless connection is abnormal when the predetermined checking time is reached;
determining whether a re-connection number or re-connection duration reaches a predetermined threshold when the connection status or communication quality of at least one of the wireless connections is abnormal;
performing a re-connection process with respect to at least one of the wireless connections having the abnormal connection status or communication quality when the re-connection number or re-connection duration is less than the predetermined threshold;
determining whether the first wireless connection and the second wireless connection are able to be established after the re-connection process is performed; and
maintaining the duplex mode of operation when the first wireless connection and the second wireless connection are established.

5. A wireless communication method, comprising:
attempting to establish a first wireless connection;
attempting to establish a second wireless connection using a different channel from the first wireless connection;
determining whether the first wireless connection and the second wireless connection are established;
coordinating a manner of signal transmission between the first wireless connection and the second wireless connection to transmit uplink data and downlink data, respectively, when the first wireless connection and the second wireless connection are established, such that a duplex mode of operation is realized; and
transmitting the uplink data and the downlink data by using the established wireless connection when only one wireless connection is established, such that a backup mode of operation is realized.

6. The wireless communication method of claim 5, wherein the first wireless connection and the second wireless connection use the same or different frequency bands in the duplex mode.

7. The wireless communication method of claim 5, further comprising:
aborting the attempt to establish the connection when the first wireless connection and the second wireless connection are unable to be established;
determining whether a predetermined checking time is reached after the attempt to establish the connection is aborted; and
re-attempting to establish the first wireless connection and the second wireless connection when the predetermined checking time is reached.

8. The wireless communication method of claim 5, further comprising the following steps after the backup mode of operation is realized:
aborting the attempt to establish the connection;
determining whether a predetermined checking time is reached after the attempt to establish the connection is aborted;
re-attempting to establish the other wireless connection when the predetermined checking time is reached; and
coordinating the manner of signal transmission between the first wireless connection and the second wireless connection to transmit the uplink data and the downlink data, respectively, wherein the operation is switched to the duplex mode when the first wireless connection and the second wireless connection are able to be established.

9. The wireless communication method of claim 5, further comprising the following steps after the duplex mode of operation is realized:
determining whether a predetermined checking time is reached;
determining whether a connection status or communication quality of the first wireless connection and the second wireless connection is abnormal when the predetermined checking time is reached;
determining whether a re-connection number or re-connection duration reaches a predetermined threshold when the connection status or communication quality of at least one of the wireless connections is abnormal;
performing a re-connection process with respect to at least one of the wireless connections having the abnormal connection status or communication quality when the re-connection number or re-connection duration is less than the predetermined threshold;
determining whether the first wireless communication and the second wireless communication are able to be established after the re-connection process is performed; and
maintaining the duplex mode of operation when the first wireless connection and the second wireless connection are established.

10. The wireless communication method of claim 9, further comprising the following steps when the re-connection number or re-connection duration reaches the predetermined threshold:
determining whether only one wireless connection is established;
transmitting the uplink data and the downlink data by using the established wireless connection when only one wireless connection is established only, and switching the operation to the backup mode; and
switching the operation to an initial mode when the first wireless connection and the second wireless connection are unable to be established, and aborting the attempt to establish the connection.
